(19) United States
(12) Patent Application Publication
(10) Pub. No.: US 2006/0230666 A1
(43) Pub. Date: Oct. 19, 2006

(54) Method and apparatus for long line and recreational bait fishing

(76) Inventor: Patrick E. Moffitt, Califon, NJ (US)

Correspondence Address: Glen M. Diehl;Norton & Diehl LLC, Suite 110, 77 Brant Avenue, Clark, NJ, 07066, US

(21) Appl. No.: 11/108,470

(22) Filed: Apr. 18, 2005

(51) Int. Cl. A01K 79/00; A01K 85/00

(52) U.S. Cl. 43/4.5; 43/42.36; 43/42.05

(57) ABSTRACT

Method and apparatus for long line fishing and for recreational bait fishing are disclosed. The method attaches bait to a line at a material distance from an attached and preferred circle hook. Separation of hook and bait on a line is sufficient to prevent the hook from entering a fish's mouth simultaneously with the bait. The method and apparatus are equally applicable to the branch line used in the commercial longline fishery and the line used in the recreational fishery. Line and bait attachment devices are described that allows a bait to slide on the fishing line, detach from the bait or be fixed thereon. A fish is hooked by striking bait affixed to the line at a distance from a hook. A fish's forward speed or an angler jerking the rod causes the line to be drawn through the fish's mouth and continues to pull the externally located hook until it engages with the outside of the jaw. The direction of hook-set is diametrically opposite traditional bait fishing methods. A circle hook's mechanical efficiency is improved by this method such that a recreational angler can strike a fish with the rod in traditional fashion. Separation of bait and hook by a material distance prevents a fish from swallowing a hook and promotes the survival of released fish. Additionally a line, rigged in accordance with the method, promotes the exclusion of sea turtles, sea birds and sharks from a longline catch.

### BACKGROUND OF THE INVENTION

The present invention relates to methods and apparatus applicable to recreational bait fishing and to commercial longlining. The method of the present invention provides increased survival of fish following release and enhances the exclusion of turtles, sea birds and sharks from a catch during commercial long line fishing.

Recreational and commercial longline fishing methods attach bait directly to a hook connected to a line. Bait is impaled onto the hook's point and pulled over the bend of the hook. Additionally, some large baits are tied to the hook by means of thread or wire such that bait and hook are abutted.

A wide assortment of hook styles and designs are available to the commercial and recreational fishing market. Hooks are available that incorporate a range of styles including hook points parallel to the hook shank and others with the hook point equal to or greater than 90 degrees in relation to the shank. The relationship of the hook point with respect to the hook shank is of particular interest to the present invention. Despite the continuum of hook designs available they can be broadly classified as either J-hooks or C-hooks also known as circle hooks. The Atlantic States Marine Fisheries Commission (ASMFC) made the following hook distinction: “A circle hook is defined as a non-offset hook with the point turned perpendicularly back to the shank”. ASMFC further opined that a detailed distinction between a circle hook and a J-hook may not be possible without causing undue confusion but would be enforceable as written. See Special Report 77 Circle Hook Definition and Research Issues, ASMFC July 2003.

A commercial longline is most often rigged with a circle hook. A fish is captured in the longline fishery by taking the bait into its mouth. The fish, continuing to swim with the bait against the tightened branchline causes the hook point to engage an internal body part and fix the fish to the line. A circle hook is preferred because the current embodiment of circle hook use requires the fish's force to set the hook and thus lends itself to this static style of fishing.

The most common hook used in the recreational fishery is the J-hook. The angler jerking the rod in response to a fish's take forces the J-hook point, moving in a relatively straight path, to pierce an internal body part.

The direction of applied force needed to set the hook is different for the two hooks. A circle hook, unlike the J-hook, cannot drive its hook point into the fish along a straight path because of the perpendicular orientation of the point to the hook shank. The force, due to the circular shape of the hook, accelerates toward the center of the hook by centripetal mechanics and engages the point.

A significantly larger circle hook compared to a J -hook must be used in the current embodiment of bait fishing. This is due to the circle hook's relatively narrow gape formed by the 90-degree point to hook shank orientation. Some fishery agencies are requiring the use of exceptionally large circle hooks to preclude the capture of non-targeted species. It is believed that large hooks may exclude species and fish size classes unable to swallow the hook. Large hooks, however, can diminish the likelihood a fish will select a bait and may result in more damage to a released fish.

Many fish and other species, such as sea turtles and birds, are incidentally killed in the recreational and commercial longline fishery.

Certain fish captured in the recreational fishery are required to be released by law. Such fish include, those undersized, in excess of the bag limit or out of season. Fish are also released resulting from an angler's desire not to retain the catch. Many fish die following release due to mortal injuries sustained from a swallowed hook. Injuries are associated with damage to internal organs such as the stomach, liver, gill arch, eye orbit and related hemorrhaging. Fish also succumb to the cumulative stresses related to handling and hook removal.

The severity of the problem is revealed in the 2003 Atlantic Striped Bass Study submitted to Congress by NMFS and USFWS. The report cites that 1.1 million of the 14 million striped bass released in 2002 subsequently died of hook related injuries. This unintended loss represented 25 to 30% of the entire recreational striped bass harvest.

Fish mortality rate following release increases significantly when a hook is swallowed. The probability a fish will swallow a hook is 17.2% for J-hooks (striped bass data) and 3.2% when using non-offset circle hooks. Post release mortality as a direct consequence of swallowing the hook is 53.1% with J-hooks and 23.5% with circle hooks. The higher mortality for J-hooks was attributed to the J-hook's point being more likely to penetrate the heart or liver causing severe bleeding. (1999 Striped Bass Catch and Release Results, Md. DNR by Rudy Lukacovic Fisheries Biologist.)

Government agencies, including the States of New Jersey and California, are seeking to decrease the incidence of post release mortality of spawning and/or threatened fish by mandating the use of circle hooks for selected fisheries. Many anglers, despite the resource benefits attributed to the circle hook, resist using circle hooks in non-regulated areas. Studies have demonstrated primary angler resistance is directly related to the caution against jerking the rod to set the hook.

Additionally, circle hooks have a tendency for the hook point to roll back into the bait and obscure the point. A circle hook with its point obscured, which can easily occur with a variety of bait types, severely reduces the odds that a fish will be caught. This limitation increases angler resistance to circle hook use. The larger size hook needed for circle hook bait fishing as compared to the smaller J-hook has also been cited.

A commercial longline rig is comprised of four main components, The components are: the mainline or groundline, the branch line (snood or gangion), the hook and bait. Commercial longlining releases a main line from the stern of a boat. The mainline can be up to 100 kilometers in length andis attached at the distal end to some form of buoy or anchor. The mainline can be oriented vertically or horizontally and be rigged to float or sink to the bottom depending upon the type of fish intended for capture. Connected to this main line at regular intervals are branch lines or snoods each terminating in a baited hook. A single mainline may contain 35,000 baited hooks. More than 1 billion baited hooks are set each year in the world's oceans by the commercial longline fishery with some recent estimates as high as 10 billion baited hooks.

The incidental death of threatened and endangered sea birds and turtles caused by longline fishing are growing concern for international governments. The Sea Turtle Restoration Project estimates the annual marine life toll from longlining to be 40,000 sea turtles and 330,000 sea birds including 22 endangered species. Additionally, millions of sharks are discarded or finned annually by this fishing method.

Sea birds, following a commercial fishing boat, dive for the baits and become impaled on the attached hooks. The birds drown as the longline rig sinks below the surface. The endangered albatross is a particular concern of world agencies. See, the Incidental Catch of Sea Birds by Longline Fishing: Worldwide Review and Technical Guidelines for Mitigation, Food and Agriculture Organization of the United Nations. FAO Circular #937 Food and Agriculture Organization of the United Nations, Rome 1999, FIIT/C937 ISSN 0429-9329.

Research directed towards the mitigation of sea bird losses include thawing out frozen bait causing it to sink faster (giving sea birds less chance to retrieve), a tube to deliver the hooks sufficiently below the surface so birds have no access to the bait, bird scare devices on the ship or main line, weighting the main line for faster sinking, setting lines at night when birds are less active and dying the baits so they are less visible to birds. Longline Fishing—What Can Be Done?, The Royal Society for the Protection of Birds.

Sea turtles are also killed by this method of fishing. Sea turtles eat many of the same baits used in the longline fishery. A turtle swallowing a baited hook may die from hook related internal injuries or, unable to return to the surface, drown.

Some areas of the world's oceans have been set off-limits to longlining and others are being considered to prevent the further decline of sea turtle populations. Research into means to prevent these unacceptable losses include using baits not favored by turtles, baits or hooks too large for a turtle to swallow, requiring hooks to be set below a turtles feeding depth, shark decoys, soaking baits in substances that would deter turtles, devices attached to the hook to prevent the turtle from being able to swallow the hook and covering the hook points with a dissolvable substance which would only expose the hook once below the turtle's feeding zone. Catch Fish Not Turtles Using Longlines, U.S. Western Pacific Regional Fisheries Management Council, The Blue Ocean Institute, February 2004. A solution to the incidental sea bird and turtle mortality by longline fisheries is a high priority for the U.S National Marine Fisheries Service as well as other national and international agencies.

As such, there is a vital need to resolve the problems relating to the incidental mortality of fish, sea birds and sea turtles inherent with current methods of recreational and commercial bait fishing.

### SUMMARY OF THE INVENTION

The method provides a comprehensive means for both the recreational and commercial longline bait fishery to enhance the survival rate for released fish and exclusion of turtles, birds and sharks from a catch. The method additionally improves the hooking mechanics of circle hooks and overcomes the main objections to their use by recreational anglers.

The method accomplishes these benefits by separating the hook at a material distance from the bait when rigged to a fishing line. The hook when rigged according to this method is therefore un-baited and bare. Separation of bait and hook applies equally to the recreational angler's fishing line as well as the commercial longliner's branch line. All of the previously described research goals for the mitigation of sea bird and sea turtle by-catch can be obtained by this one method.

A fish taking the bait, in accordance with the present invention, does not have the hook and bait simultaneously enter its mouth. Fish, turtles and sea birds, therefore, cannot swallow the hook and are not subject to the associated injuries.

A fish is captured by engulfing bait connected to a line at a distance from a hook. The hook at the time the fish takes the bait is outside the fish's mouth. The line, as the fish swims away. is pulled through the mouth until the externally located hook is drawn into the outer jaw. The direction of hook-set is diametrically opposite traditional fishing methods where hook and bait simultaneously enter the mouth cavity. Traditional bait fishing finds the hook being pulled from inside the mouth for hook-set while the present invention allows for the hook to be pulled from outside the body and into the jaw for hook-set.

The present invention describes devices for attachment of bait to the line and not to a hook. The devices can keep the bait rigidly to a specific point on the line or slide down the line when pressure is applied. The devices as described can be permanently affixed to the line or may be removed by the angler without the need for breaking the line or untying knots.

The present invention describes a means whereby bait can be attached by means of a mechanical tagging fastener.

Additionally the method allows for the bait, to be pulled free of, or remain in the fish's mouth during hook-set.

Further, a rig is described capable of excluding sharks from a longline catch as well as promoting the catch of large leader shy fish in the recreational fishery.

### DESCRIPTION OF THE DRAWINGS

FIG. 1 shows a fishing rig in accordance with one aspect of the present invention.

FIG. 2 shows a fish engulfing the bait on the fishing rig of FIG. 1 with the hook on the outside of the fish's mouth.

FIG. 3 shows the ultimate engagement of the hook into the fish's jaw.

FIG. 4 shows one aspect of the present invention where the attachment device and bait are rigidly attached to the fishing line.

FIG. 5 shows another aspect of the present invention where the bait is pulled from the bait attachment device that is more rigidly affixed to the line, thereby allowing the bait to remain in the mouth while the hook engages the fish.

FIGS. 6 to 7 illustrate a means for shark exclusion from a longline catch.

FIG. 8 demonstrates the preferred connection of line and hook.

FIGS. 9 to 21 illustrate various embodiments of a line attachment device and bait fastener in accordance with several aspects of the present invention.

FIG. 22 illustrates a commercial longline fishing rig in accordance with one aspect of the present invention

### DESCRIPTION OF THE PREFERRED EMBODIMENT

The rigging options possible with this method are equally applicable to the branch longline fishery branch line and recreational fishery fishing line and hereafter termed the line.

The method and apparatus of the present invention attaches bait(s) to a line at distances of several inches to multiple feet from a hook, such as a C hook, also known as a circle hook. Distance between hook and bait is a function of targeted species, size, bait and angler preference. In a preferred embodiment the hook does not simultaneously enter or contact the mouth when the fish first takes the bait. Bait and hook, to accomplish this goal, must be separated by a sufficient distance. Many of the fish targeted by the longline fishery are ram-suction feeders. Suction forces produced by the mouth opening and forward speed of these fish allow them to engulf food items at distances, forward of their mouth, equal to 1.5 times the length of their head. The formula, 1.5 times the length of a targeted fish's head, offers a guide to preferred minimum bait to hook separation distance.

A fish, when engulfing a line baited in accordance with this method, swims away against a tight line (commercial) or causes the angler to strike with the rod (recreational) drawing the line through the mouth. The continued line pull ultimately engages the circle hook into the jaw. The separation of hook from bait is sufficient to prevent a turtle or bird from swallowing the hook and associated risk of mortal injuries. The method continues to be efficient at capturing fish.

Any hook type can be used with the method of the present invention. Circle hooks, however, are preferred with respect to J-hooks. While the J-hook is capable of working with this method, it has a greater tendency of foul hooking fish in locations outside of the mouth. The J-hook has a point that is parallel to the hook shank allowing the hook to pierce whatever body part it comes in contact as the hook is being drawn along the outside of the fish's body. The J-hook, as a result, has a higher probability of foul hooking a fish in an area other than the mouth. C or Circle hooks have a point perpendicular to the hook shank, and they require the hook to contact a defined edge in order to engage the fish. The perpendicular orientation of hook point to hook shank allows the circle hook to pass unimpeded until striking the defined edge of the outer jaw.

In accordance with the preferred embodiment a non-offset, straight-eye and barb-less circle hook is used.

In accordance with a preferred embodiment of the present invention, the circle hook is tied to a line such that the line departs the hook-eye at a point below the shank and is ultimately knotted to the shank of the hook. A typical line to hook connection is the Snell knot.

Fish capture efficiency results in large part from the method's direction of hook-set which is diametrically opposite that used for traditional fishing methods. The hook by this method is outside the fish's mouth when the fish first takes the bait. The line draws the hook towards the fish causing the hook to engage in the outside jaw. The outside jaw provides the attached circle hook with a more defined edge for engagement when compared to conventional fishing's opposite hook-setting direction. Circle hook efficiency is a function of the edge shape it first encounters during hook-set. The more defined the edge the greater the hook-set efficiency. The outer jaw cannot be contacted with traditional hook-setting techniques.

The more defined edge, as a result of this outside-in hook-set direction, also allows the use of significantly smaller circle hooks. Smaller hooks produce far less damage than larger hooks in released fish. As an example, conventional bait fishing for trout suggests a size 6-circle hook for small fish and a size 2-circle hook for larger trout (What's Your Point? By J. Merwin, Field and Stream, Feb. 28, 2005). The method described herein allows the use of the smallest size circle hook, size 18, commercially available when fishing for large trout.

A hook pulled initially from outside a fish's mouth and into the jaw provides the circle hook with a more defined edge for hook-set. The more defined edge found when reversing the direction of the hook set allows the angler to strike or jerk the rod when using circle hooks. Striking at a fish's bite is currently not recommended when using circle hooks.

Improved hook-up percentages with fish are found when using a circle hook and bait separated by distance. Circle hooks can have problems associated with the hook point rolling back into the bait. Roll back prevents the hook from contacting an edge, rolling into position and engaging. The method, by separating hook from bait, overcomes this drawback. The above benefit is equally important to the recreational and commercial fisheries.

Bait can be fixed above a hook on a line by a variety of devices that are dependant upon the size and type of bait and angler preference. The apparatus associated with fixing bait to a line include: line attachment devices, bait fasteners and bait stops.

A line attachment device fixes bait to a particular point on a line or prevents bait from slipping below a fixed point prior to a fish taking the bait. Line attachment devices can be fixed permanently to a line by means of crimps, knots or other methods known to fishing or may be loop connected, tortuous path or clipped to the line allowing for removal.

The method and apparatus of the present invention allows for a variety of line attachment devices to keep the bait rigidly or yieldingly attached to the line. As an example, in a preferred embodiment small baits may be rigidly affixed to a line to be easily pulled from the fish's mouth during the period the line is drawing the hook to the jaw. Fishing efficiency with larger baits may be improved if the bait is yieldingly attached to the line such that the line slips through the attachment device, or the bait is allowed to detach from the bait fastener or the line attachment device, keeping the bait in the fish's mouth while the hook is drawn to the jaw. The alternatives, leaving a bait in the mouth or pulling it free, are dependant upon how much force is required to extract the bait and if in so doing insufficient force remains for hook-set.

The present invention allows for bait fasteners that work in conjunction with the line attachment device. A bait fastener generally incorporates a structure or structures capable of affixing the bait to the fastener. These include but are not limited to “T” barbs angled barbs or clasp. The distal end of the bait fastener has an attachment mechanism for fixing the bait fastener to the line attachment device. Attachment is accomplished by means of loops, clips, pressure fitting, friction, and other obvious means to connect the two pieces together. The distal end and barbed end do not have to be constructed of similar materials.

In a preferred embodiment of the present invention, large baits have the bait fastener inserted with a tagging gun familiar to those in fisheries, such as fish ID tags, and the garment industry where it is used to attach tags to clothing.

A single device can also function as a line attachment device and bait fastener. In this case the bait fastener has barbs on one end that are inserted into the bait and an eye on the distal end. A loop of fishing line is loop connected to the eye. The eye is crafted form a polymeric material with a coefficient of friction sufficient to keep the bait yieldingly or rigidly in place on the line. In a preferred embodiment the eye is made from an elastomeric polymer. The eye can also be attached to the line by a knot in which case the eye can be crafted from a variety of materials. The eye and the bait attachment end do not have to be similar materials.

A bait can additionally be affixed to the line by attaching a bait stop at a desired point on the line forward of the hook. A bait stop is similar to a freshwater bobber stop. The bait stop can be a bead or other shaped structure threaded onto a line and held in place with a length of braided line snelled to the line at a point below thebait stop. The braided knot keeps the beadat a certain point on the line while fishing but is able to be repositioned by hand. The bait stop can additionally be crimped, looped, knotted or fixed to the line by tortuous path eliminating the need for the braided line. The bait stop may be formed from elastic or rigid materials and sized appropriate to the bait fastener. In a preferred embodiment the bait stop has prongs pointing away from the hook which aid in keeping the bait from prematurely sliding toward the hook.

Bait can be attached in one of two ways with a bait stop. The first method inserts the hook point into the bait, pulling the hook through the bait and up the line and finally drawing the bait stop into or through the bait such that it is positioned on the line at a point on or above the bait stop. This method is preferred with baits that are sufficiently cohesive not to tear free of the line or the bait stop.

In an alternate preferred embodiment bait is connected to a bait fastener with distal end containing an eye. The eye is threaded over the hook, up the line and pulled over the bait stop. The eye and/or bait stop are elastic in nature allowing the device(s) to be initially stretched when the bait fastener is pulled over the bait stop. The bait stop and/or bait fastener eye, once pressure is released, returns to a size that does not permit the bait fastener to slip below the bait stop.

Multiple bait attachment points, depending on the size, type or texture of the bait, may be used with a single bait. Multiple attachment points are preferred for large and/or heavy baits to allow the line to orient with the long axis of the bait. This orientation keeps large baits from spinning and entangling the line as well as promoting hook set efficiency.

The method, especially when small baits are used, allows for multiple bait attachment devices and multiple attached baits fixed at separate points along a single line rigged with a single hook.

Devices associated with baiting and affixing bait to a line may be constructed of any material suitable for the purpose, including plastics, biodegradable synthetics, natural rubber or metals.

Many targeted fish in the longline fishery feed by a ram-suction process. This leads to the fish engulfing the bait in a single coordinated motion. This fish's forward speed provides the force needed in commercial longlining and most recreational circle hook fishing for hook setting. Non-targeted species, such as turtles, are not ram-suction feeders. They will, especially with larger baits, slow considerably to feed. When the method and apparatus of the present invention is used, a turtle's slow swimming speed, in contrast to the speed of a tuna or marlin, will not exert the necessary force to set the hook. A turtle's relatively slow feeding style also gives it adequate time to feel the line's resistance and expel the bait prior to being hooked. A turtle's mouth cavity is protected on the outside by a bony beak. The method's outside in hooking mechanics forces the hook to attempt engaging this structure and not the soft tissue of the interior mouth. The method's ability to use smaller hooks enhances the probability that the hook will strike the bony structure of the beak and prevent the hook from setting.

The method of the present invention can mitigate sea bird losses incurred by the long line fishery. Sea birds, attempting to lift the hook-less bait from the water are forced to drop the line. The weight of the longline rig pulls the line free from the bird prior to it becoming impaled on the hook.

The inventive method can exclude sharks from a longline catch. Bait is fixed onto a section of branch line forward of the hook and capable of being parted by the bite of a shark. This forward section of branch line is then connected to a highly abrasion resistant line or shock leader ultimately connected to a hook Sharks are excluded from the catch by allowing them to bite through the forward line prior to the more abrasion resistant section of branch line being drawn through its mouth and engaging the hook. The length of the distal abrasion resistant or shock leader should be equal to the length of the targeted fish. The separation of hook from bait must therefore be greater than the length of the abrasion resistant branch line section. A similar rig allows the recreational angler the benefit of a shock leader while affixing bait to a less noticeable line section. Shock leaders can dissuade a keen eyed fish from taking bait connected to a heavy and highly visible line. Rigging and hook attachment are similar for recreational and commercial alternatives.

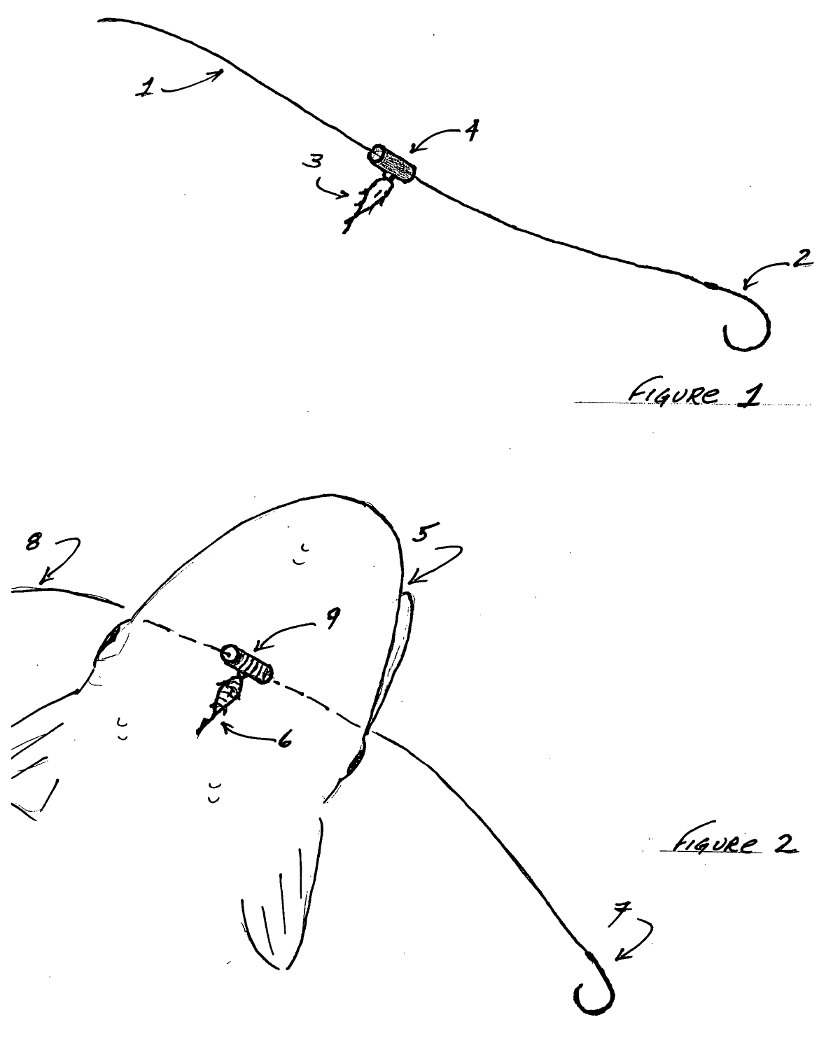

Referring to FIG. 1, basic rigging in accordance with one aspect of the present invention is illustrated. A fishing line 1 is attached to a hook 2. The hook 2 is preferably a C or circle hook, but may also be a J hook or other hook. The bait 3 is yieldingly attached to the line by means of an attachment device 4.

FIG. 2 shows a fish 5 engulfing the bait 6. The hook 7 is located outside of the fish's mouth as the fish 5 strikes the bait 6. As the fish 5 moves away, the line 8 is pulled in the direction of the fish 5, drawing the hook 7 closer to the mouth. This action occurs when the hook is “set” by the person fishing or a fish moving against a taut branchline.

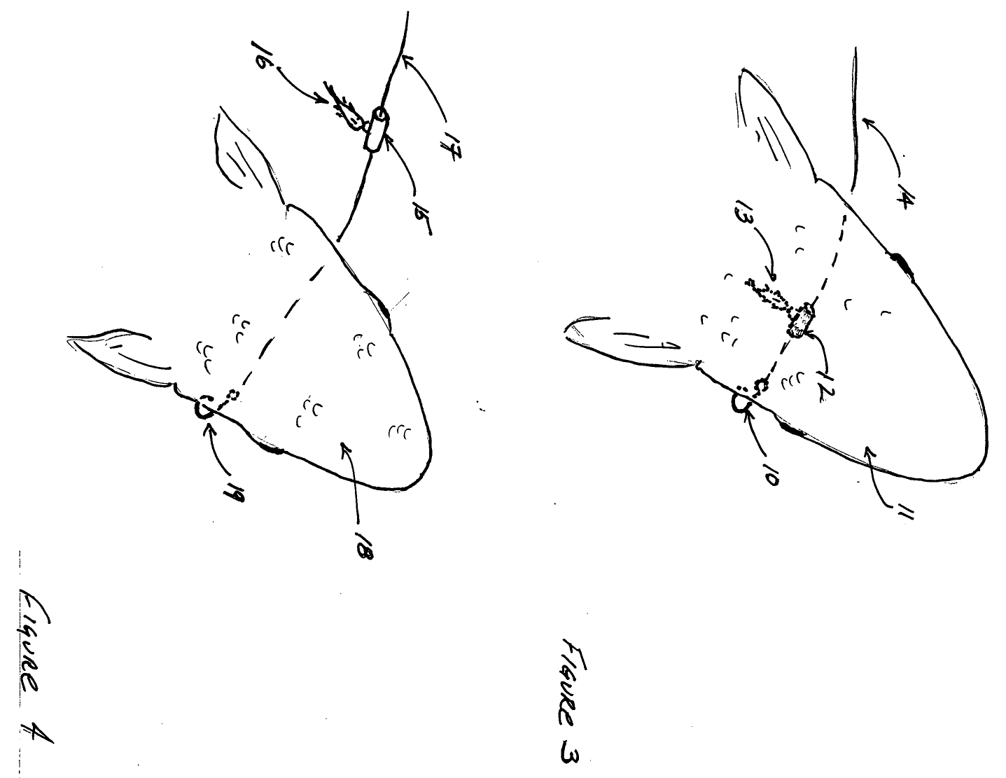

FIG. 3 shows the ultimate engagement of the hook10 into the fish's jaw 11 with the attachment device 12 and the bait 13 having remained in the mouth by sliding down the line 14. Note that the hook 10 penetrates the fish 11 outer jaw. Thus, the hook 10 does not enter the fish's mouth cavity and is exposed for simple extrication.

FIG. 4 illustrates an attachment device 15 and bait 16 rigidly attached to the line 17. In this case, the attachment device 15 is pulled from the mouth of the fish 18 prior to the hook 19 engaging the fish 18 in the jaw. The bait 16 is illustrated as also being pulled from the mouth of the fish 18.

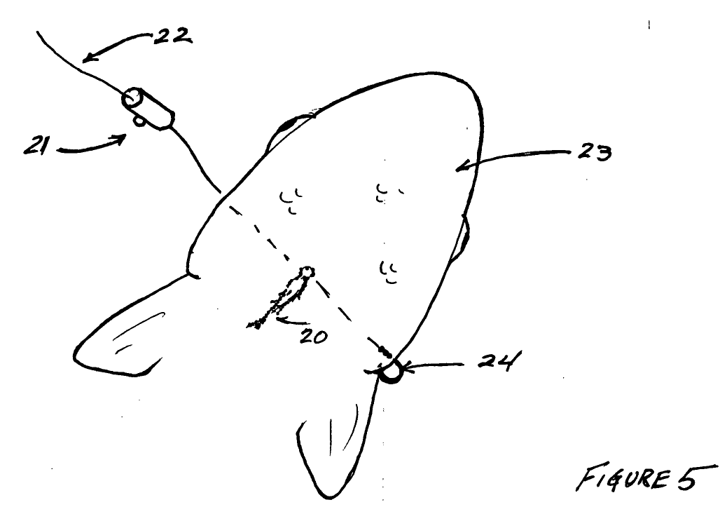

FIG. 5 shows the case where bait 20 is pulled from the line attachment device 21, that is more rigidly affixed to the line 22, allowing the bait 20 to remain in the mouth while the hook 24 engages the fish 23. It is also possible for the entire attachment device and bait to separate from the line during hook-set.

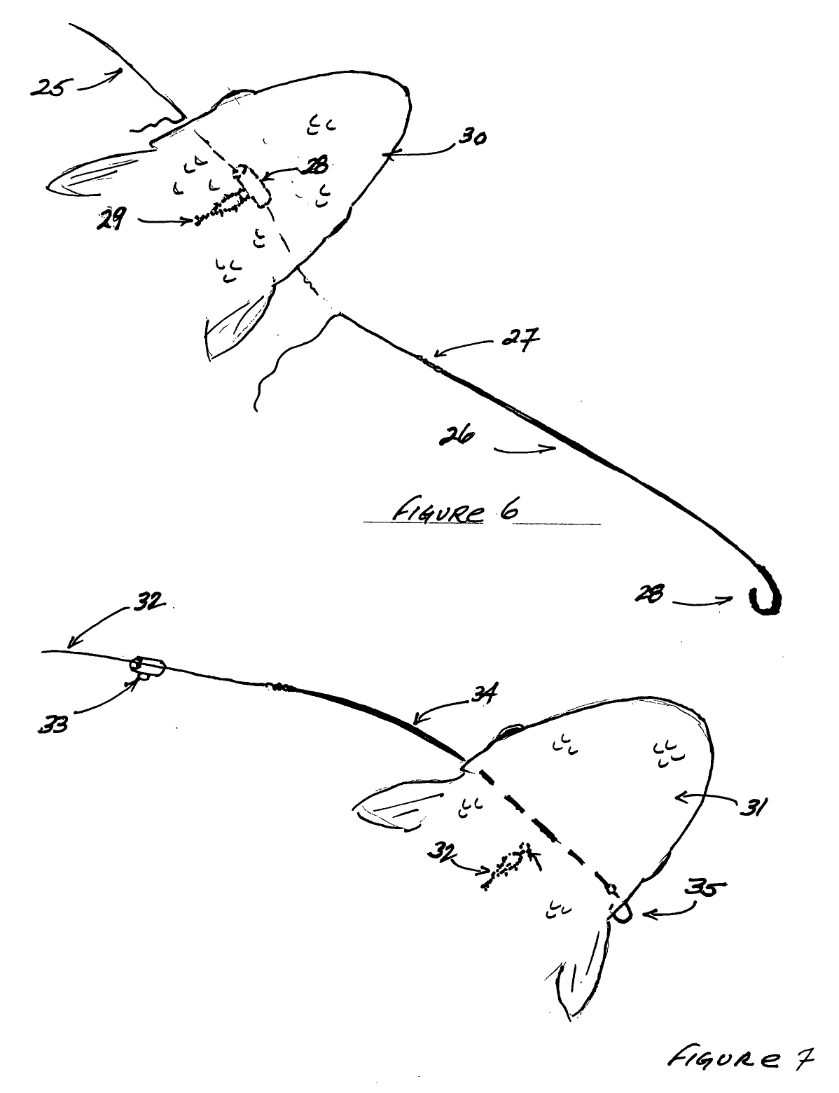

FIGS. 6 to 7 illustrate another aspect of the present invention. In FIG. 6, a line 25 is attached to shock leader 26. The shock leader 26 is attached via a knot 27 or any other known means to attach the lines. A hook 28 is attached to the shock leader section 26. A line attachment device 28 is secured to the line 25. Bait 29 is attached to the line attachment device 28. A shark 30 is shown having engulfed the bait 29 connected to a less abrasion resistant line section 25. The heavier and wire shock leader 26 and connected hook 28 is outside the fish's mouth 28 at the time of the strike. A shark is able to bite through the line 25 without being hooked.

FIG. 7 illustrates a recreational fishing alternative to fishing with a shock leader. A keen eyed fish 31 has taken the bait 32 similar to the shark described in FIG. 6. The angler having jerked the rod following the fish's strike caused the more transparent and or thinner line section 32 to be drawn through the fish's mouth 31. The line attachment device 33 connected to the bait 34 separate as a result of the force imparted by the angler pulling the line. The line continuing to be drawn pulls the line attachment device 33 free of the fish's mouth 31. The force of the angler's pull resulted in the shock leader 34 pulling the attached hook into the fish's jaw. The angler is now free to fight the fish with the shock leader in position to prevent the fish from cutting or abrading the line. The angler is thus able to present the bait to the fish on a more transparent and thinner diameter line 25 while enjoying the benefits of a shock leader 34 when fighting a fish.

FIG. 8 demonstrates a preferred connection of line 40 to a circle hook 41. The line 40 enters the hook eye 42 from the side between the shank 43 and the point 44. The line 40 is tied to the shank by any appropriate knot 45 for tying a line to a hook shank. A snell knot is commonly used.

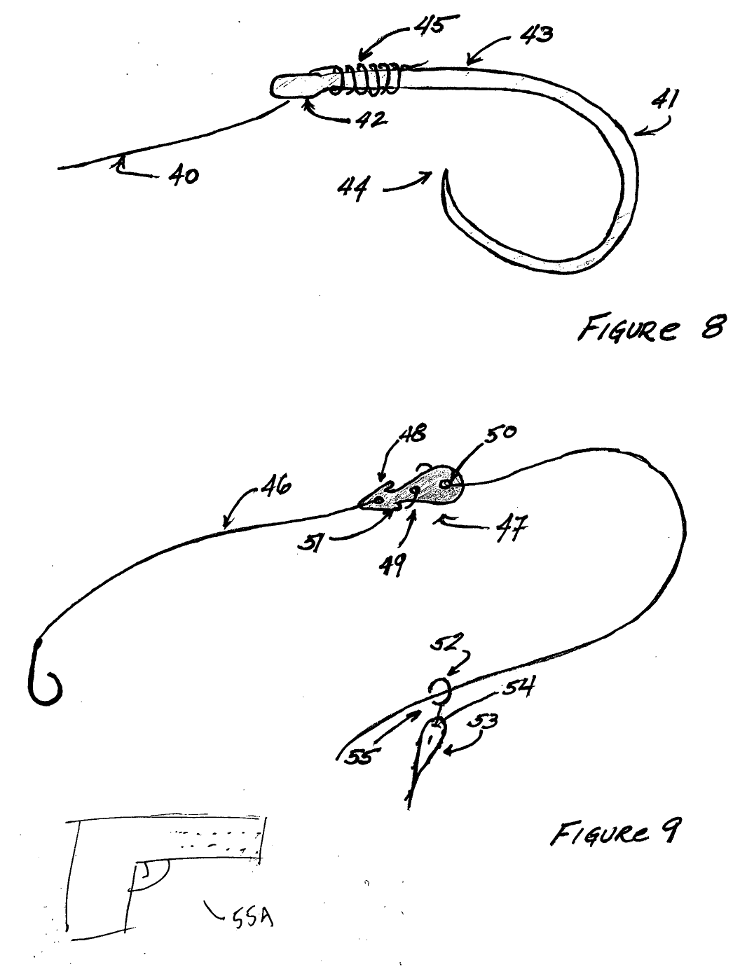

FIGS. 9 to 11 illustrate various line attachment devices and bait fasteners in accordance with one aspect of the present invention. In FIG. 9, a line 46 is threaded through a line attachment device 47 provided with a plurality of holes 48 to 50. The line attachment device has a barb point 51. A bait fastener 52 with bait 53 affixed to a T barb 54 contains an eye 55 through which a line may be threaded.

The line attachment device 47 can be constructed from a plurality of materials, as previously discussed. If it is desired that the line attachment device 47 be stationary on the line 46 when a fish strikes a bait fixed above the line attachment device 47, then the line 46 is preferably looped through the holes 48 to 50 necessary to create sufficient friction between the line and the device. On the other hand, if it is desired that the line attachment device 47 slide on the line 46 when a fish hits, the line 46 could be looped through only two of the holes 48 to 49. A line attachment device is not limited to the three-hole configuration as shown.

The line attachment device 47 has an elastic barbed 51 end. The barb 51 can work in connection with a tagging fastener 52 with eye attachment 55 to hold a bait 53 in place. The tagging fastener 52 is used with a tagging gun 55A. The tagging device is loaded into the tagging gun 55A and shot into the bait 53. Barbs or a T-shaped end 54 hold the tag in place in the bait. The tagging gun is similar to the tagging guns used in the garment industry.

Referring to FIG. 10, the eye 56 on the tagging fastener 57 is threaded over the hook 58 and over the barbs 59 on the line attachment device 60. The barbs 59 are preferably plastic and can bend inwards to allow the eye 56 of the bait fastener 57 to pass. The line attachment device 60 has an end 61 that is preferably larger than the diameter of the bait fastener eye 56 so the bait fastener 57 and bait 62 is held on the line attachment device 56.

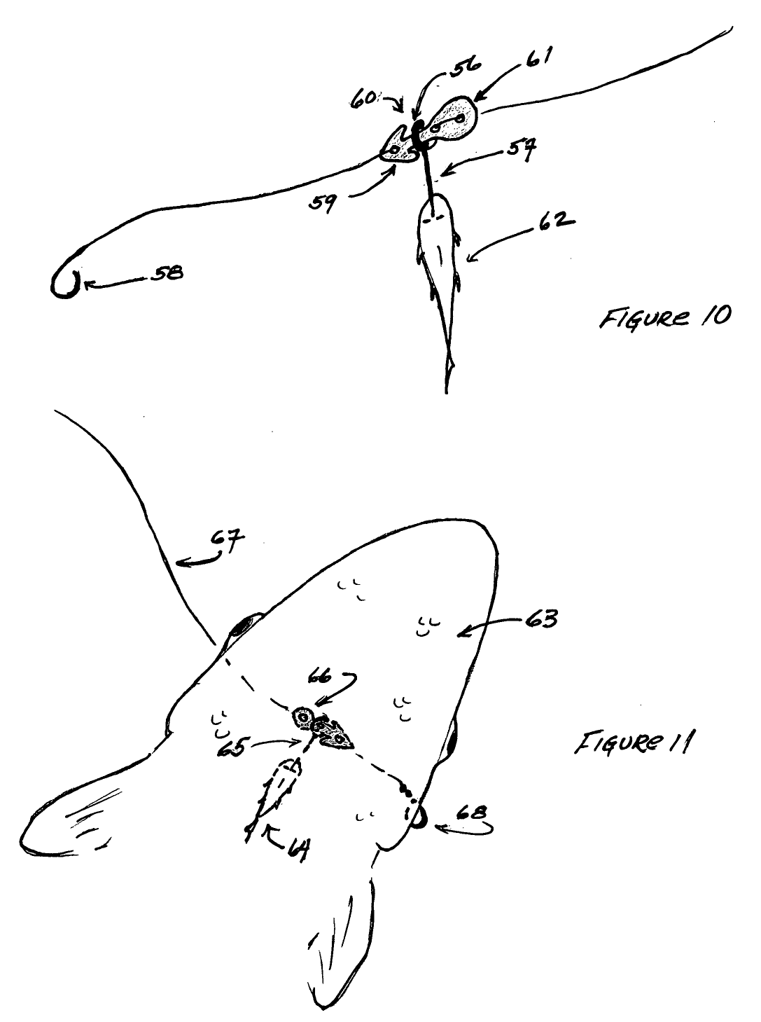

Referring to FIG. 11, a fish 63 strikes the bait 64 affixed to a bait fastener 65 connected to a line attachment device 66 as described in FIG. 10. The line 67 is attached to the line attachment device 66 so it is able to slide toward the hook 68. The hook 68 is engaged with the rigging 65 and 66 remaining in the mouth 63.

FIG. 12 illustrates another aspect of the present invention. A line attachment device 100 is attached to a line 101 in a similar manner as previously described. The line attachment device 100 has barbs 102 that extend inward. In this case, the eye 106 of the bait fastener 105 can be pulled over and free of the barbs 102 when a fish 103 strikes the bait 104. The resistance between the fish 103 and the bait 104 cause the barbs 102 on the line attachment device 100 to compress and allow the fastener eye 106 to separate from the line attachment device 100. Separation allows the bait 104 to remain in the fish's mouth 103 when the hook 107 is set.

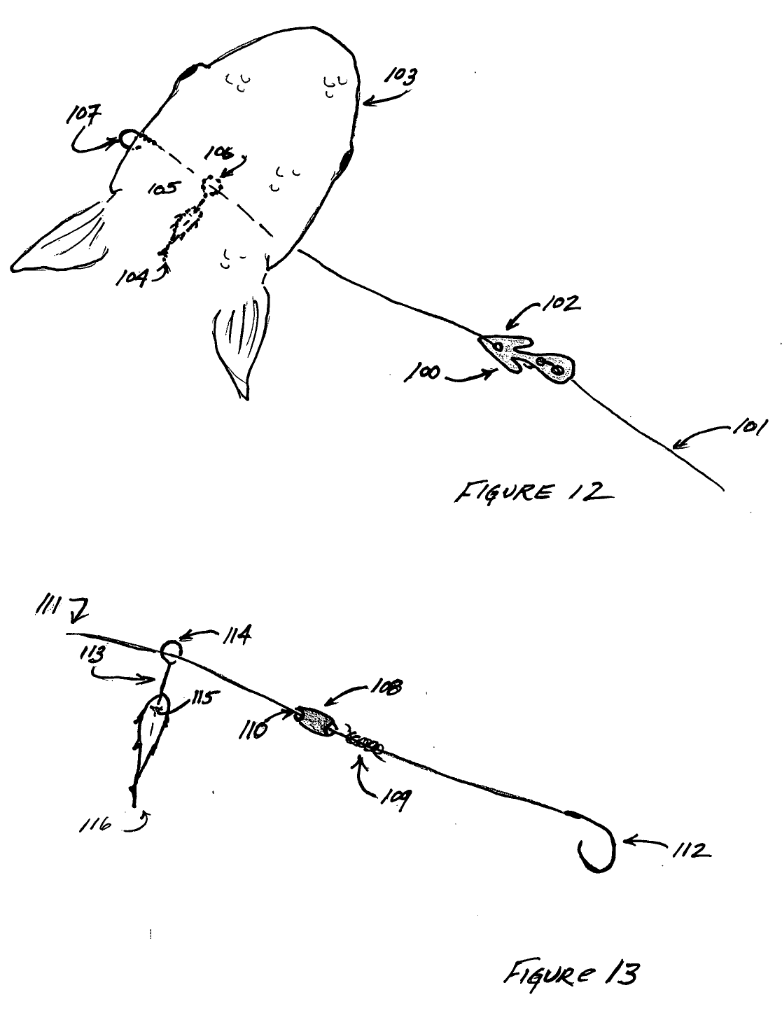

FIG. 13 illustrates an additional line attachment device 108 and 109. A bead 108 or similar device with a hole 110 through its center is threaded on a line 111 prior to attaching the hook 112. A length of braided line 109 is snell knotted to the line 111 below the bead 108. A bait fastener 113 with an eye loop 114 on one end and barbs 115 fixed to a bait 116 is clipped to the line 111 at a point above the stop device 110 and 111. The bait fastener eye loop 114 and/or bead 108 can also be elastic to allow a closed eye loop to be threaded over the hook and pulled over the bead.

FIG. 14 illustrates an alternate embodiment of a line attachment device 117. The device 117 has a hole in the center 118 and a Y-shaped end 119. In accordance with one aspect of the present invention, a line 120 is attached to the device 117 by putting a looped section 121 of the line 120 though the hole 118 and then putting the device 117 back through the looped section of line 121. A tagging fastener 122, such as device 113 illustrated in FIG. 13, can be attached to the Y-shaped end 119 of the device 117 by means of an eye loop 123 and held in place. The bait attachment device 117 is preferably made from plastic and the Y end 119 preferably yields when sufficient pressure is placed on them to either allow a tagging fastener 122 to be fixed onto the device 117 or to allow the tagging fastener 122 to be pulled free from the line attachment device 117 during hook-set.

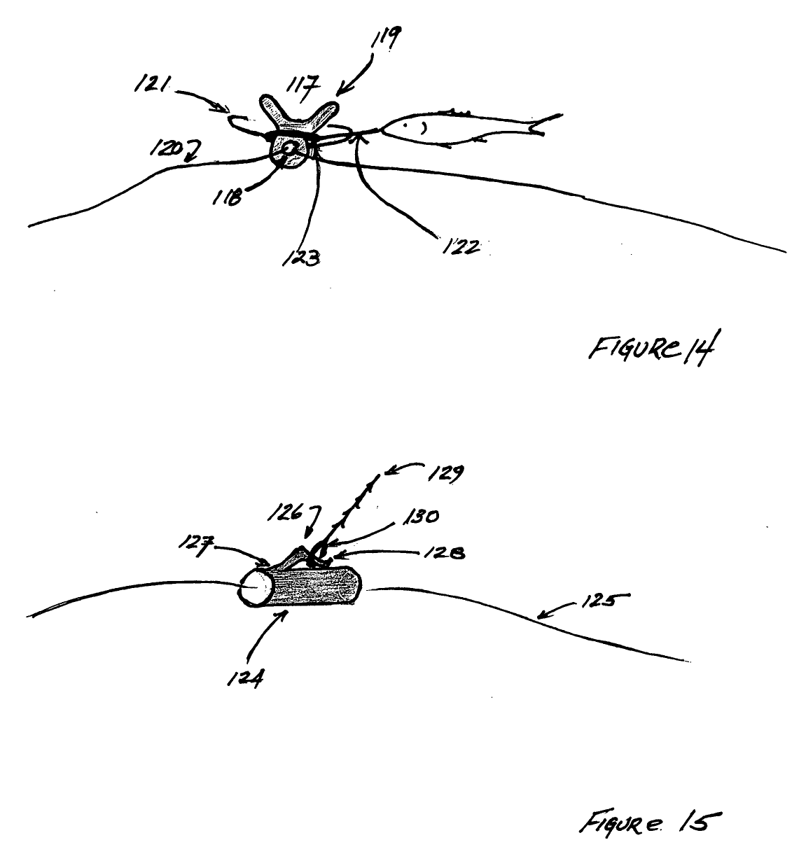

FIG. 15 illustrates another alternate embodiment of a line attachment device 124 in accordance with another aspect of the present invention. The line attachment device 124 is preferably constructed from plastic, although other materials can be used. The line attachment device 124 can be fixed to the line 125 by crimping, knots or bobber stop. The device 124 has an arm 126, which is attached to the device 124 at a first end 127 of the arm 126. The other end 128 is not connected to the device 124, but preferably comes in contact with the device 124 to be able to hold a bait fastener 129 in place. A bait fastener 129 is attached to the device 124 by means of the arm 126 and eye loop 130, as illustrated. The arm 126 has enough flexibility to allow the eye loop 130 to slide under the arm 126.

FIG. 16 illustrates another alternate embodiment of a bait fastener 131 in accordance with another aspect of the present invention. The line attachment device 132 is preferably a circular piece of plastic through, which the line 133 has been threaded. A bait fastener 131 has a T-shaped end 134 and a barbed end 135. The T end 134 is longer than the diameter of the hole in the line attachment device 132. The T end 134 is compressed and/or the line attachment device 132 stretched to affect connection. The rig can be maintained at a point above the hook by a stop device or the line 133 can be loop connected to the line attachment device 132.

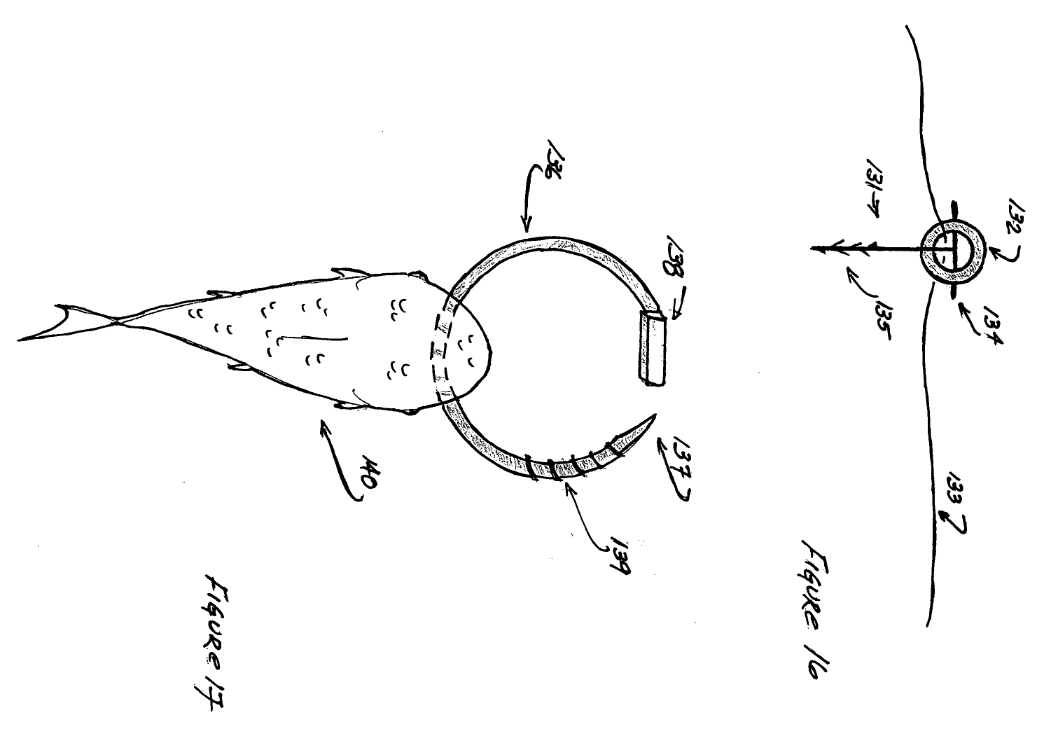

FIG. 17 illustrates another alternate embodiment of an attachment device 136 in accordance with another aspect of the present invention. The attachment device 136 is preferably plastic, and has a pointed end 137 and a receptacle 138 adapted to receive and hold the pointed end 137 in a manner well known to those skilled in the fastener art. The receptacle 138 can have a ridge inside it that holds the device 136 closed by connecting with the indents 139 when the pointed end 137 is pulled through the receptacle 138. The attachment device 136 is inserted through the bait 140 before the pointed end 137 is inserted into the receptacle 138. The bait attachment device 136 can then be connected to a line in a number of ways. It can be tied or clipped to the line or it can be fit over a Y-shaped end of a bait attachment device, such as the device illustrated in FIG. 14 or fastened to the line attachment device shown in FIG. 16.

FIG. 18 illustrates another bait fastener variation 141. The fastener incorporates a point 142 on one end and a socket 144 on the other with a fitting 145 capable of connecting to the ball structures 143. Connection is similar to common lamp cord chain. The point 142 can be threaded through a bait and the device closed by snapping the male end 143 into the socket 144. The incorporated eye loop can be clipped or fitted to any of several line attachment device previously described.

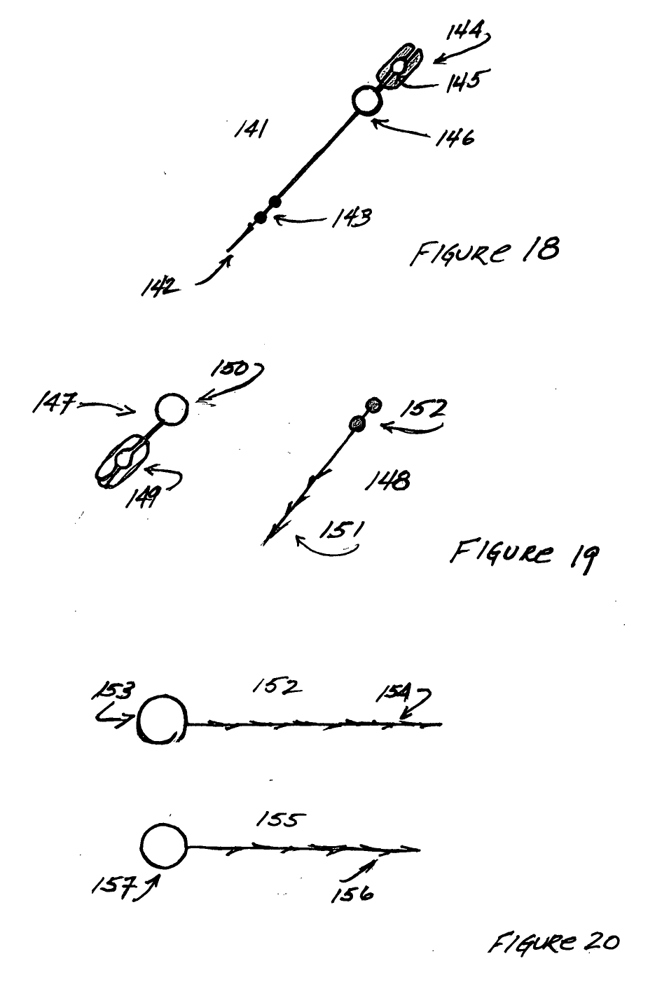

FIG. 19 shows a line attachment device and bait fastener slightly different than the attachment device 141 illustrated in FIG. 18. The line attachment device 147 incorporates a socket 149, for connection to the bait fastener 148 and eye loop 150 for connection to a line. The bait fastener 148 has a barbed end 151 for affixing bait and a fitting 152 capable of connecting to the socket 149. The eye loop 150 may be tied to a line or connected to any of the line attachment devices previously described.

FIG. 20 illustrates additional bait fasteners in 152 and 155. The bait fastener 152 has a clip end 153 and a barbed end 154. The clip end 153 can be attached directly to a line above a bobber stop or similarly described device. The clip 153 may additionally be fixed to a line attachment device. The bait fastener in 155 has a closed eye loop 157 and a barbed end 156 for bait attachment. The eye loop 157 may be connected directly to the line by looping a section of the line through the loop eye 157 and the placing the bait fastener through the looped section of line. Alternatively, the eye loop 157 can be used in connection with the bait attachment devices previously discussed, such as the ones shown in FIGS. 10, and 13 through 15.

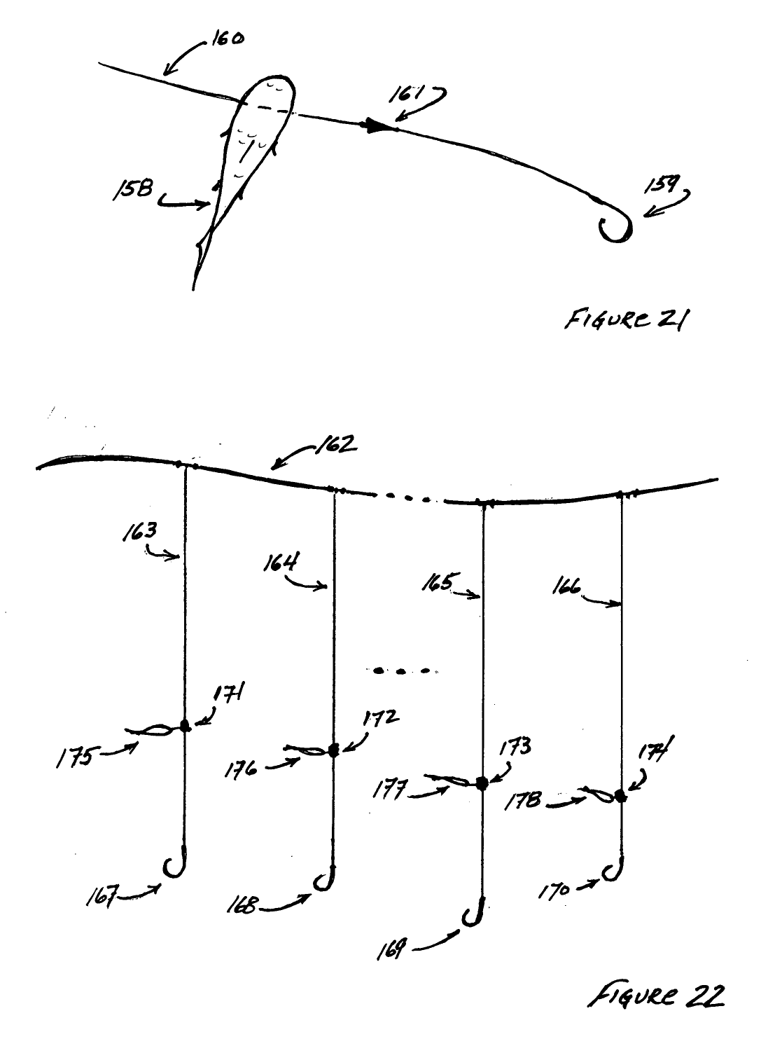

FIG. 21 illustrates a method of attaching bait to a point on a line above a hook. Bait 158 is inserted onto the point of a hook 159 and pulled over the hook and up the line 160. The bait is next pulled over a bait stop device 161 keeping the bait from sliding back towards the hook 159. The bait stop 161 can take any shape that allow the bait to be pierced and once pierced prevents the bait 158 from sliding back over the bait stop 161. In a preferred embodiment the stop device has prongs increasing in separation on the side of the stop away from the hook.

FIG. 22 illustrates a commercial long line rig in accordance with one aspect of the present invention. A long line 162 is rigged with a plurality of branchlines 163 to 166. Each of the of the branch lines 163 to 166 has a hook 167 to 170 attached at or near the end of each branch line. The hooks 167 to 170 are preferably a C hook or circle hook, although any type of hook can be used. Each of the branch lines 163 to 166 also have a line attachment device 171 to 174 attached to it at a distance from the hook 167 to 170, respectively. Bait 175 to 178 is attached to each of the line attachment devices 171 to 174, respectively. The long line 162 can stretch for a great distance and there can be thousands of branch lines like 163 to 166 attached to the main line 162.

Any of the bait attachment devices described herein can be used in this aspect of the invention.

Although the invention herein has been described with reference to particular embodiments, it is to be understood that these embodiments are merely illustrative of the principles and applications of the present invention. It will be apparent to those skilled in the art that various modifications and variations can be made in the apparatus and methods of the present invention without departing from the spirit and scope of the invention. Thus, it is intended that the present invention include modifications and variations that are within the scope of the appended claims and their equivalents.

1. A method of commercial long line fishing with a main line and a plurality of branch lines connected to the main line, comprising:
rigging a plurality of branch lines by attaching a hook at or near the end of each of the lines and by attaching a bait attachment device on each of the plurality of branch lines at a distance from the hook;
attaching bait to the bait attachment device on each of the plurality of lines; and
attaching each of the plurality of branch lines to a main line.

2. The method as claimed in claim 1, wherein the hook attached at or near the end of each of the plurality of branch lines is a circle hook.

3. The method as claimed in claim 1, wherein the bait attachment device on each of the plurality of branch lines can slide on the branch line.

4. The method as claimed in claim 2, wherein the bait stays in a fish's mouth cavity during hook setting.

5. The method as claimed in claim 1, wherein the bait attachment device is securely fixed on each of the plurality of fishing lines.

6. The method as claimed in claim 5, wherein the bait is pulled free from the bait attachment device during hooking.

7. The method as claimed in claim 1, comprising placing the main line in water.

8. The method as claimed in claim 2, comprising placing the main line in water.

9. The method as claimed in claim 7, whereby a fish moving at a fast pace strikes the bait on one of the bait attachment devices on one of the plurality of branch lines and is hooked by the hook on the one of the plurality of branch lines.

10. The method as claimed in claim 9, wherein the fish does not take the bait and the hook simultaneously into its mouth.

11. The method as claimed in claim 9, wherein the branch line is drawn through the fish's mouth.

12. The method as claimed in claim 9, wherein the hook is drawn closer to the fish's mouth as the branch line is drawn through the fish's mouth and the hook engages the fish's mouth.

13. The method as claimed in claim 12, wherein the hook is pulled from outside the fish's mouth and into the fish's outer jaw.

14. The method as claimed in claim 10, wherein the bait separates from the bait attachment device and remains in the fish's mouth.

15. The method as claimed in claim 7, whereby a slower moving species strikes the bait on one of the bait attachment devices on one of the plurality of fishing lines and is not hooked by the hook on the one of the plurality of fishing lines.

16. The method as claimed in claim 15, wherein the slower moving species includes turtles and birds.

17. The method as claimed in claim 16 wherein the slower moving species includes non-targeted fish such as sharks.

18. A method of recreational bait fishing, comprising:
rigging a fishing lines by attaching a hook at or near the end of the line and by attaching a bait attachment device on the lines at a distance from the hook; and
attaching bait to the bait attachment device on the line.

19. The method as claimed in claim 18, wherein the hook is a C hook.

20. The method as claimed in claim 1, wherein the bait attachment device can slide on the line.
